(19) United States
(12) Patent Application Publication
(10) Pub. No.: US 2005/0041043 A1
(43) Pub. Date: Feb. 24, 2005

(54) Apparatus and a method for performing sampling digital image

(76) Inventors: Jin-Sheng Gong, TaoYuan Hsien (TW); Issac Chen, KaoHsiung (TW)

Correspondence Address: BRUCE H. TROXELL, SUITE 1404, 5205 LEESBURG PIKE, FALLS CHURCH, VA, 22041, US

(21) Appl. No.: 10/615,980

(22) Filed: Jul. 10, 2003

(30) Foreign Application Priority Data
Nov. 7, 2002 (TW) 91115760

(51) Int. Cl. G09G 5/00

(52) U.S. Cl. 345/660

(57) ABSTRACT

A method and an apparatus for down-scaling an input image. The input image is composed of a series of image frames which are continuous in a time sequence. These image frames is grouped into at least a first set and a second set of image frames which are continuous and interchanging with each other. Sampling models employed in the present invention are typically following the method of skip-through. However, pixels contained in different sets of image frames are sampled by using different sampling models such that the lost of critical graphic information (e.g. pixel data) can be minimized after down-scaling. These sampled pixels of each image frame of each set are then output continuously by following the same order in the same time sequence. As a result, the complexity in both operation and architecture of the apparatus and the method of the present invention are reduced, and the problems of image blurring and losing partial image data which might otherwise happen in the prior arts are also solved.

### BACKGROUND OF THE INVENTION

(a). Field of the Invention

The present invention relates to a method and an apparatus for sampling digital image, more particularly, to a method and an apparatus for down-scaling a digital image.

(b). Description of the Prior Arts

In the digital image system, the conversion of video format is accomplished by changing the corresponding sampling frequency for the digital image. For instance, the process for up-scaling 800×600 pixels of the image frame to 1024×768 pixels of the image frame. Such kind of process can also be referred as “up-sampling” or “up-scaling”. On the other hand, the process for down-scaling 1024×768 pixels of the image frame to 800×600 pixels of the image frame is referred as “down-sampling” or “down-scaling”.

The conventional methods for down-scaling an image frame are skip-through and interpolation. The skip-through method is an image frame adopting directly the m ost neighboring pixel of the down-scaling point in the original image frame. Yet, the interpolation method, which can be a liner interpolation or other kinds of polynomial interpolation, is an image frame adopting the intermediate value calculated using the neighboring pixels of the down-scaling point in the original image frame. FIG. 1 represents a schematic diagram depicting the resulting image with 5:4 down-scaling ratio using the skip-through method and the method of interpolation.

Generally speaking, the interpolation method, though will still cause an image blurring problem, can acquire a more accurate image compared with the skip-through method. Nevertheless, the interpolation method is implemented via an addition and multiplication operation of more than two original image pixels. Therefore, it is very costly to realize since it is necessary to store at least twice the original image pixels. In addition, the implementation of the circuits of the adder and the multiplier is costly as well. Please refer to FIG. 2, which is a schematic diagram depicting a circuit using interpolation. The circuit includes a horizontal line interpolation circuit 11 or/and a horizontal pixel interpolation circuit 12, a line data buffer 13, a down-scaling control circuit 14, and a data buffer 15, wherein the interpolation circuit comprises an adder and a multiplier. The multiplier can be excluded if only ½ accuracy of the interpolation is required.

The hardware structure for realizing the skip-through method is very simple. Please refer to FIG. 3, which is a schematic diagram depicting a circuit using skip-through method. The foregoing circuit includes a down-scaling control circuit 21, a horizontal line skip-through selection output circuit 22 or/and a horizontal pixel skip-through selection output circuit 23, and a data buffer 24. However, the down-scaled image using the skip-through method cannot retain sufficient image data, since the method skips some image data and directly employs the rest portion of the original image pixels as its resulting image. For instance, when applying the skip-through method for down-scaling, a “T” pattern in the original image can become a “-” pattern or “I” pattern, sometimes even can disappear totally according to its original position in the original image.

Since the conventional methods are adopted for down-scaling, some original image information is due to lost. Under the circumstance, the object of down-scaling is to retain sufficient vital information for displaying. Accordingly, an extremely accurate interpolation is neither necessary nor meaningful to the users. In addition, a simple interpolation (½ accuracy) without multiplier sacrificing the quality of image is still in demand of a complex hardware structure to implement. Moreover, even worse that the down-scaled image using the skip-through method is unacceptable because the significant information might be lost. Therefore, the object of the present invention is to use the skip-through method for down-scaling and still retains sufficient vital image information with an accuracy equivalent to the simple interpolation (½ accuracy).

### SUMMARY OF THE INVENTION

In view of the aforementioned drawbacks, the present invention is to provide a method and an apparatus which can down-scale a digital image via processing a series of images following a time sequence.

Another object of the present invention is to provide a mechanism that can preserve the original image data after down-scaling.

Yet another object of the present invention is to provide a method and an apparatus having the same realization cost as the skip-through method, but still having sufficient image data for recognition.

Yet another object of the present invention is to provide a method and an apparatus having the effect of simple interpolation with ½ accuracy.

Every conventional down-scaling method only considers the application for a single image frame, and never before considers the application for a series of continuous image frames. In the present invention, if an image frame A is succeeded by an image frame B, the image information skipped during down-scaling of the image frame A using the skip-through method will reappearing in the image frame B, that is, the complete image is still available for the user to recognize, and needs only to add an initial offset mechanism for achieving the down-scaling effect.

For the image composed of texts, the more original image information preserved during down-scaling, the better recognition can be achieved. Down-scaling using interpolation can cause image blurring which is not good for text recognition, on the other hand, the present invention can preserve more original image information which is more advantageous to text recognition compared with the down-scaled image using interpolation. Besides the original image, text recognition can benefit from less information switching between image frames A and B by using an initial offset setting.

For the graphic image, the method of the present invention can accomplish the effect of simple interpolation by setting an initial offset through utilizing the effect of persistence of vision.

In order to achieve the foregoing object, the device for down-scaling a digital image according to the present invention comprises: a FIFO-type data buffer and a down-scaling control circuit. The FIFO-type data buffer stores the pixels after down-scaling so as to overcome the asynchronous read/write problem in a real-time system. The down-scaling control circuit is used to decide whether the current inputting pixels should be written into the FIFO-type data buffer to act as the resulting output image of down-scaling. Thus, the present invention can utilize the persistence of vision via a selection of pixels from different position within a series of continuous images to achieve the object for down-scaling a digital image.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a schematic diagram depicting the resulting image with 5:4 down-scaling ratio using the conventional skip-through method and the conventional interpolation method.

FIG. 2 is a schematic diagram depicting an interpolation circuit of prior art.

FIG. 3 is a schematic diagram depicting a skip-through circuit of prior art.

FIG. 4 is a diagram schematically showing an embodiment of the apparatus for down-scaling a digital image according to the present invention.

FIG. 5 is a signal control diagram of the apparatus shown in FIG. 4 for down-scaling a digital image according to the present invention.

FIG. 6A and FIG. 6B are embodiments of the oscillograms of the signals shown in FIG. 5 of the present invention.

FIG. 7 is an architectural diagram of the control circuit 42 for down-scaling a digital image according to the present invention.

FIG. 8A is an embodiment of the decision unit 72 for odd/even image frame in accordance with the present invention.

FIG. 8B is an embodiment of the oscillogram of the input/output signals of the decision unit 72 shown in FIG. 8A.

FIG. 9 is an architectural diagram of the selectors 73/74 within FIG. 7.

FIG. 10A to FIG. 10C are exemplary drawings schematically illustrating the result of down-scaling a digital image by using the method and apparatus of the present invention.

FIG. 11B is a preferred embodiment showing an initial offset accumulator with Offset0=0 [symbol] Offset1=(M/N)−1 of the present invention.

FIG. 11A is an oscillogram of FIG. 1B.

FIG. 12 is a preferred embodiment showing an 8 bits initial offset accumulator with Offset0=¼′ [symbol] Offset1=¾ of the present invention.

FIG. 13 is chart listing the simulation data of down-scaling according to the present invention.

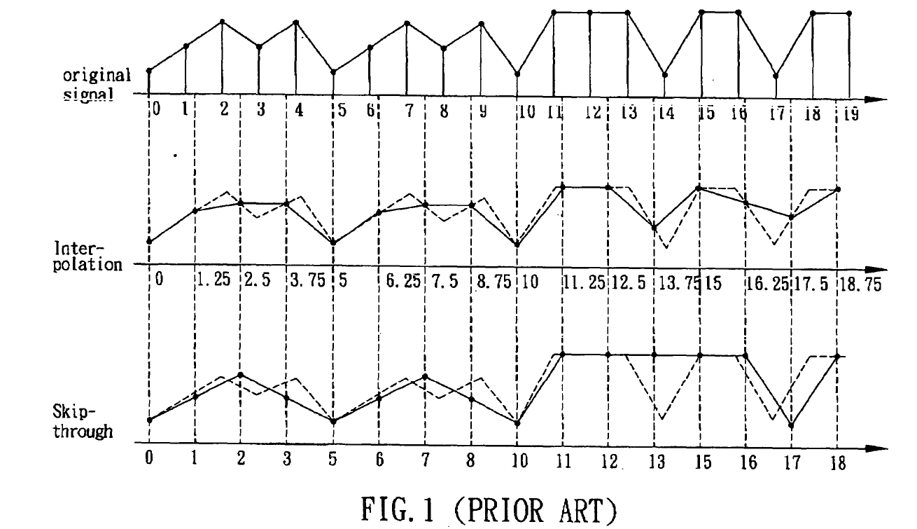

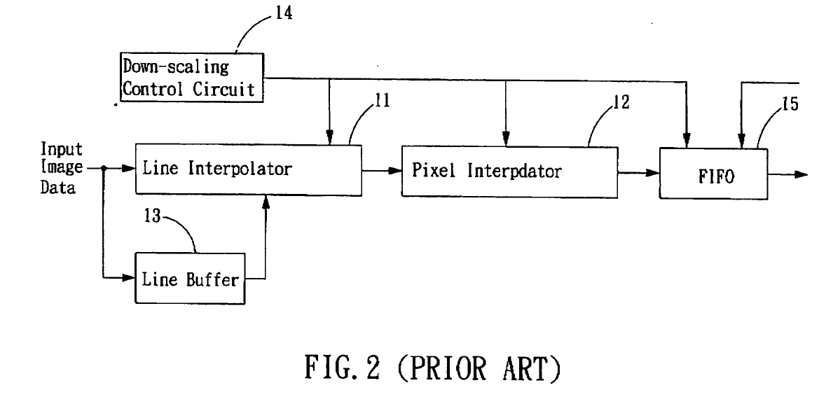

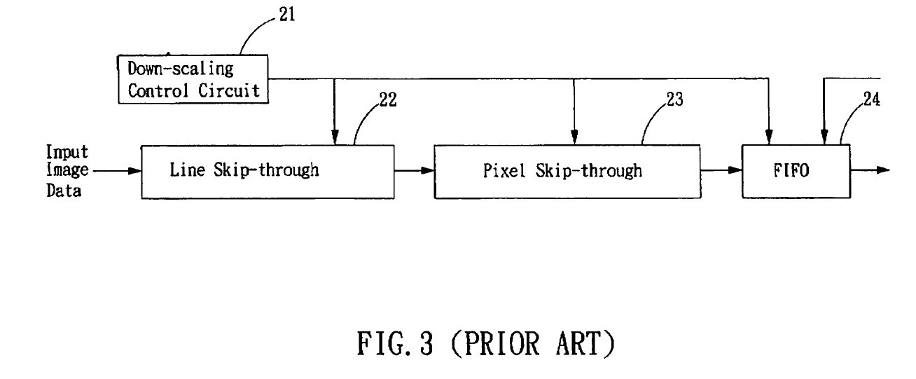

### DETAILED DESCRIPTION OF THE PRESENT INVENTION

The following embodiments will illustrate the apparatus and the method for down-scaling the continuous digital images of the present invention in detail.

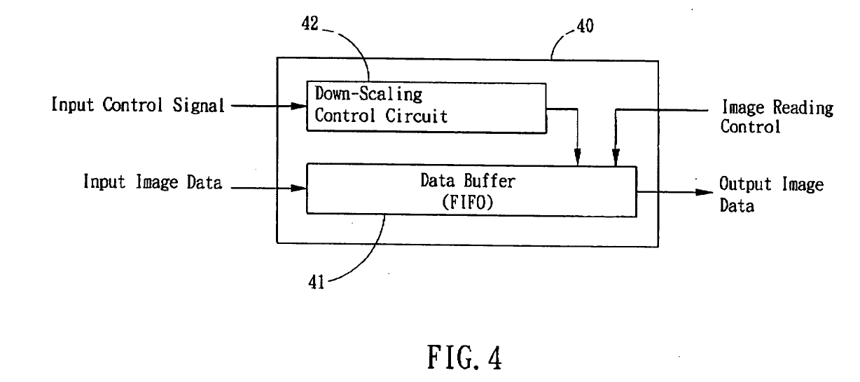

As show in FIG. 4, which is a diagram schematically showing the apparatus for down-scaling a digital image in accordance with the present invention. The apparatus 40 for down-scaling the continuous digital images of the present invention comprises a FIFO-type data buffer 41 and a down-scaling control circuit 42. Basing on the image scaling, the coordinate of pixel and the frame number, the read control logic within the control circuit 42 of the down-scaling apparatus generates a Write Enable (WE) signal needed by the data buffer 41 for writing some selected digital image pixel data into the data buffer 41. Accordingly, the pixel data outputted from the data buffer 41 will be the resulting image of the apparatus 40 for down-scaling the continuous digital images of the present invention.

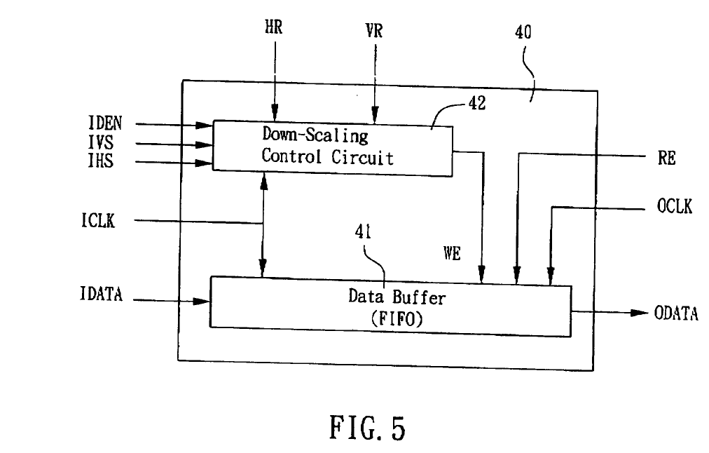

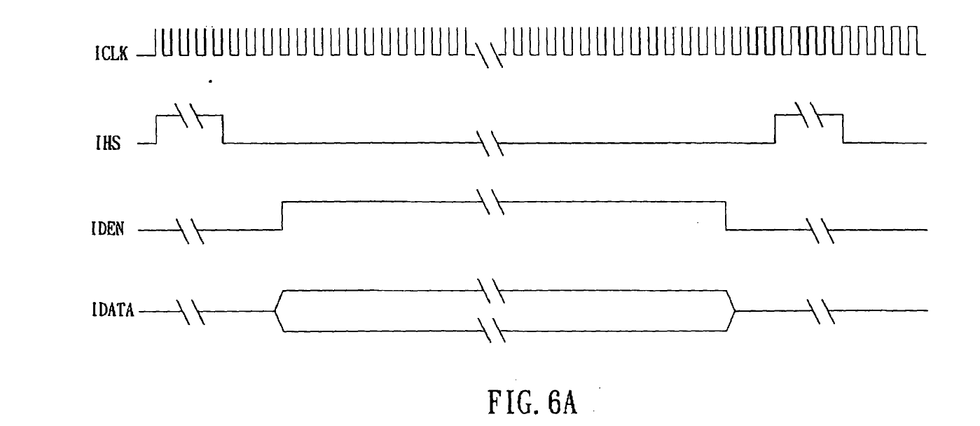

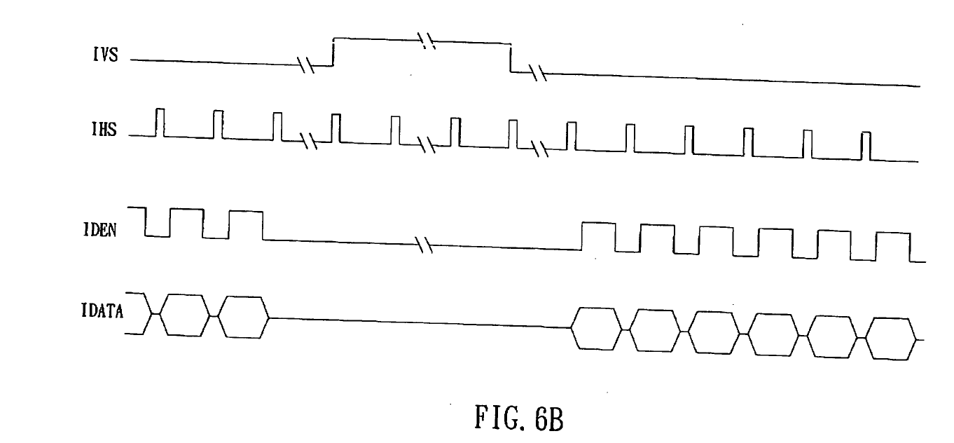

FIG. 5 is a signal control diagram of the apparatus for down-scaling a digital image according to the present invention. The embodiment using input signals, such as ICLK, IVS, IHS, IDEN, IDATA, are shown with reference to FIG. 6A and FIG. 6B. As the signal waveforms shown in FIG. 6A and FIG. 6B, wherein ICLK is the clock signal of the input image; IVS is the initial signal of the image frame being input thereto; the period of the IVS signal is the period of the signal image frame within the image; IHS is the initial signal for the horizontal line of the input image; IDEN is the pixel data instruction signal; IDATA is the pixel data of input image employing ICLK as clock while IDEN is equal to 1. Within the foregoing signals, the variations of IDATA, IHS, and IDEN are synchronized with ICLK, and the variation of IVS is synchronized with IHS. Moreover, the relationships between ICLK, IVS, IHS, and IDEN are fixed for every image frame of the image. As show in FIG. 6A, which is an image data signal diagram schematically depicting a horizontal line of an image frame. When IDEN is equal to 1 (high), the IDATA signal employs ICLK as clock to indicate the pixel data of a horizontal line of the image frame. And, the next time when the IDEN signal becomes 1 again, the pixel data of the next horizontal line are indicated. On the other hand, when the IDEN is equal to 0 (low), it represents the pixel data interval between every horizontal line. The signals shown in FIG. 6B are the image signal diagram depicting a plurality of horizontal lines of the whole image frame. Wherein, when IVS is equal to 0 (low), the pixel data of the plural horizontal lines transmitted by IDATA signals can display the whole image frame. And, when IVS is equal to 1 (high), it represents the interval between image frames.

As seen in FIG. 5, OCLK signal represents the clock signal for reading the down-sampled data from the data buffer 41 using a posterior device (*not shown), and RE signal represents the Read Enable signal (RE), wherein the output signal ODATA is the down-scaled pixel data.

The input signals HR and VR of N bits are used to set up the horizontal and vertical down-scaling ratio of the present device. For instance, if N equals to 4, and an operation is proceeded to down-scale an image frame from 20×9 to 16×8, then the horizontal and vertical down-scaling ratio respectively are 5/4 and 9/8; when using the binary system to represent the decimal part of the down-scaling ratio, then HR=¼*2⁴=[0100], VR=⅛*2⁴=[0010].

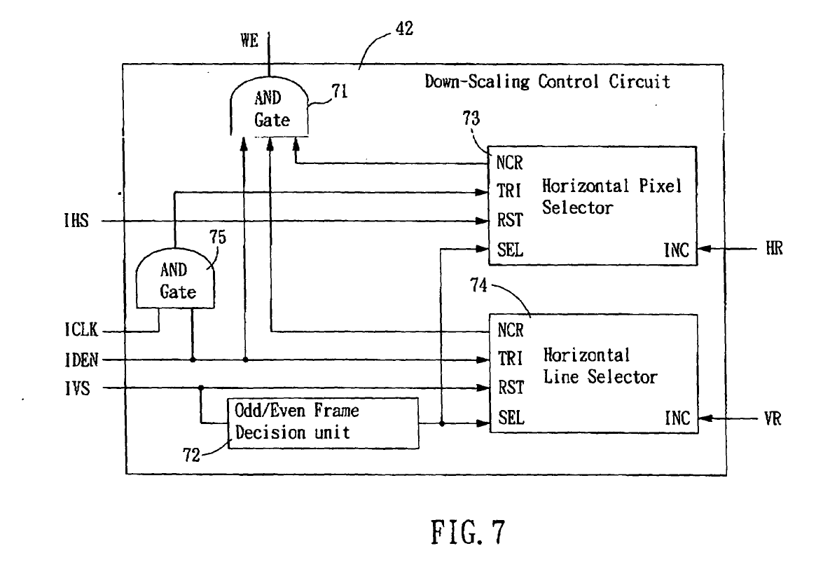

FIG. 7 is a schematic block diagram of the device for down-scaling a digital image according to the present invention. As shown, the read control logic of the down-scaling control circuit 42 comprises: a 3-terminal AND gate 71, an odd/even frame decision unit 72, a horizontal pixel selector 73, a horizontal line selector 74, and a 2-terminal AND gate 75.

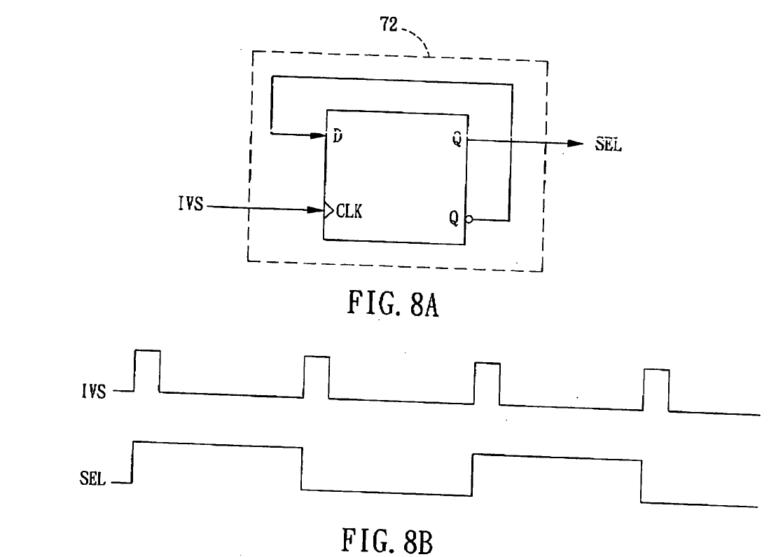

The function of the 3-terminal AND gate 71 is to perform an AND logical operation on the selection signal NCR and the IDEN signal so as to output an WE signal needed for storing image data IDATA into the data buffer 41. Wherein the selection signal NCR is generated by the horizontal pixel selector 73 and the horizontal line selector 74, while the IDEN signal is inputted from outside. If the NCR outputted from the horizontal pixel selector 73 is equal to 0 (low), then the pixel data is skipped. That is, the pixel data will not be written into the data buffer 41. If the NCR outputted from the horizontal line selector 74 is equal to 0 (low), then the horizontal line is skipped. That is, the whole horizontal line will not be written into the data buffer 41. One embodiment of the odd/even frame decision unit 72 is a D-type flip-flop as shown in FIG. 8A. The D-type flip-flop using the initial signal IVS of the input image as a trigger signal to generate a SEL signal. Please reference to FIG. 8B. The continuous image frames of the input image can be divided into the interlacing odd image frames and even image frames according to the SEL signal.

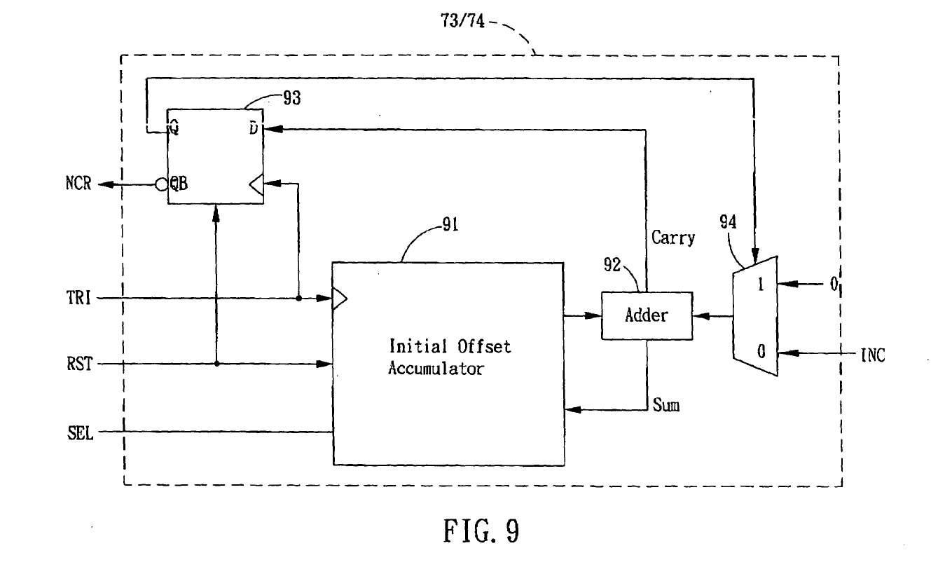

The structure/architecture of the horizontal pixel selector 73 is similar to the horizontal line selector 74 with reference to FIG. 9. When the trigger signal TRI changes from 0 to 1, the Sum of the N b its a dder 92 will be entered into the N bits initial offset accumulator 91, and also the overflow signal (Carry) of the adder 92 is entered into the D-type flip-flop 93. The positive output Q of the D-type flip-flop 93 is used for controlling the value outputted from the multiplexer 94 to the adder 92 to be either 0 or INC. The inverse output QB of the D-type flip-flop 93 outputs the selection signal NCR. The input image data IDATA will not be written into the data buffer 41 when the NCR is equal to 0. When the reset signal RST is equal to 1, clearing the output of the flip-flop 93 (NCR=1). When SEL=0, the initial offset of the initial offset accumulator 91 is “Offset0”. And, when SEL=1, the initial offset of the initial offset accumulator 91 is “Offset1”.

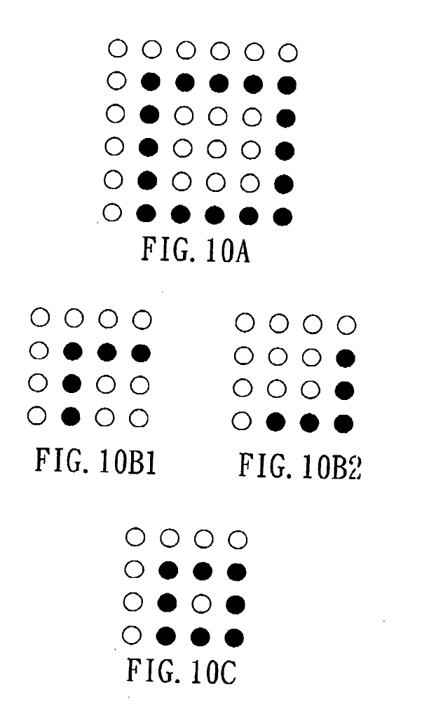

The concept for sampling the digital image by using the digital image down-scaling apparatus 40 of the present invention can be briefly demonstrated by FIG. 10A, FIG 10B1, FIG. 10B2 and FIG 10C. In the present embodiment, the input image seen by human eye is composed of the continuous display of the 6×6 single image frame of FIG. 10A. If the image frame is down-scaled to 4×4, the down-convert ratio is 3:2. Therefore the ideal down-scaling positions (also referred as “sampling positions” hereinafter) of the image frame of both vertical and horizontal coordinates are 0, 1.5, 3 and 4.5. But if using the skip-through method to carry out the down-scaling, the down-scaling positions of the image frame of both vertical and horizontal coordinates will be 0, 1, 3 and 4, and the output down-scaled digital image will be as the one shown in FIG. 10B1. As a result, some critical graphic information (e.g., pixel data) of the original image frame is lost, and it becomes difficult to realize the original image frame (e.g., the one shown in FIG. 10A) from the down-scaled digital image as seen in FIG 10B1. If an offset 0.5 is added to the ideal down-scaling position 0, 1.5, 3, 4.5 and now the down-scaling positions are 0.5, 2, 3.5, 5, then the down-scaling positions using the skip-through method become 0, 2, 3, 5. And then, the output down-scaled digital image will be the one shown in FIG. 10B2, which is similar to FIG. 10B1, that some critical graphic information of the original image frame is still missing even with an offset. However, it is notable that the overall graphic information of the original image frame is distributed partially in FIG. 10B and partially in FIG. 10B2. That is, by putting FIG. 10B1 with FIG. 10B2 together, one will have all of the original graphic information of the image frame. Therefore, if interchanging FIG. 10B1 with FIG. 10B2 rapidly and continuously in a time sequence, because of the persistence of vision, the image seen by human eye will be the totality of FIG. 10B1 and FIG. 10B2, and the overall graphic information of the original image frame can be displayed as the one shown in FIG. 10C without the drawbacks of the conventional method.

In view of the foregoing outcome, it is conceived that image is composed of continuous image frames and can be treated as interlacing odd image frames and even image frames. According to the concept of a digital image down-scaling apparatus 40 oft he present invention, the process to down-scale M pixels on the vertical or horizontal coordinate of a digital image to N pixels (wherein M, N are positive integers, and N<M<2N) is as following:

For the even image frame, the ideal down-scaling positions are M/N*X+Offset0, where X is an increasing sequence of integers between 0 and N−1, that is, the outcome of down-scaling the even image frame is the composition of N pixels located at the integer coordinate of M/N*X+Offset0 out of the original M pixels.

For the odd image frame, the ideal down-scaling positions are M/N*X+Offset1, where X is an increasing sequence of integers between 0 and N-1, that is, the outcome of down-scaling the even image frame is the composition of N pixels located at the integer coordinate of M/N*X+Offset1 out of the original M pixels.

The continuous output images are composed of the outcomes of down-scaled even image frames and odd image frames. Therefore, every pixels of the original image are preserved in the continuous output images that, through the persistence of vision, the overall graphic information of the original image frame can be displayed.

The mechanism using the coefficients Offset0 and Offset1 of the initial offset accumulator 91 can have different design according to different purpose. The two designing concepts of the present invention are: (1) minimizing image frame variations, and (2) approaching the effect of simple interpolation with ½ accuracy.

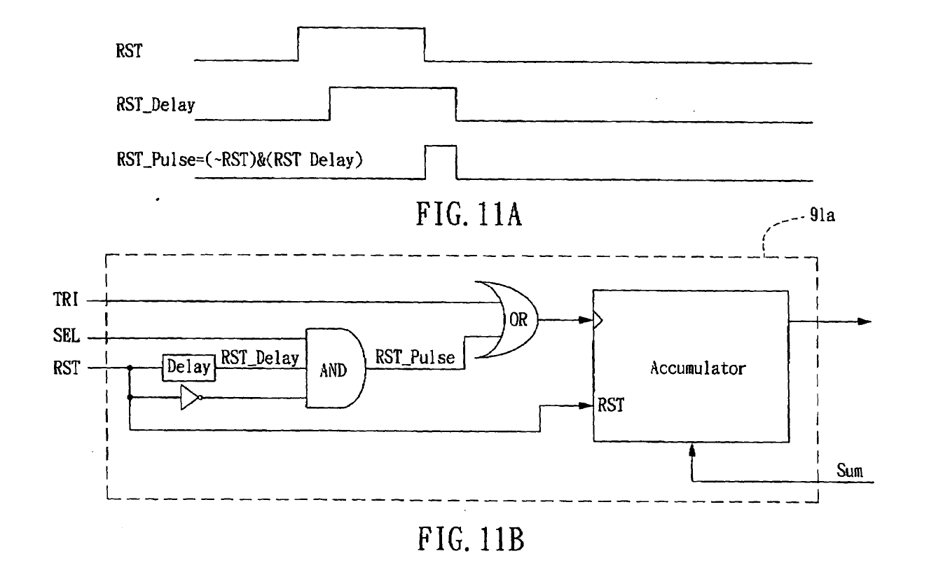

The object of minimizing image frame variations is to enable the continuous output images to have as many identical output points as possible, so that the output down-scaled image will be more stable and clear. Consequently, for user's sake, the texts within the image are easier for recognition. To fulfill this object, the difference between Offset0 and Offset1 should be equal to the residue of M/N, that is, |Offset1−Offset0|=(M/N)−1. Please refer to FIG. 11A and FIG. 11B, which take the design of Offset0=0, and Offset1=(M/N)−1 for example. That is, while RST is finished, an RST_Pulse is created as seen in FIG. 11A, thus, when RST=1, sets Offset0=0. In the condition that if SEL=1 and PST_Pulse=1, then the Sum of the adder is loaded into the accumulator as Offset1. FIG. 11B is an embodiment of initial offset accumulator 91 a with Offset0=0, and Offset1=(M/N)−1.

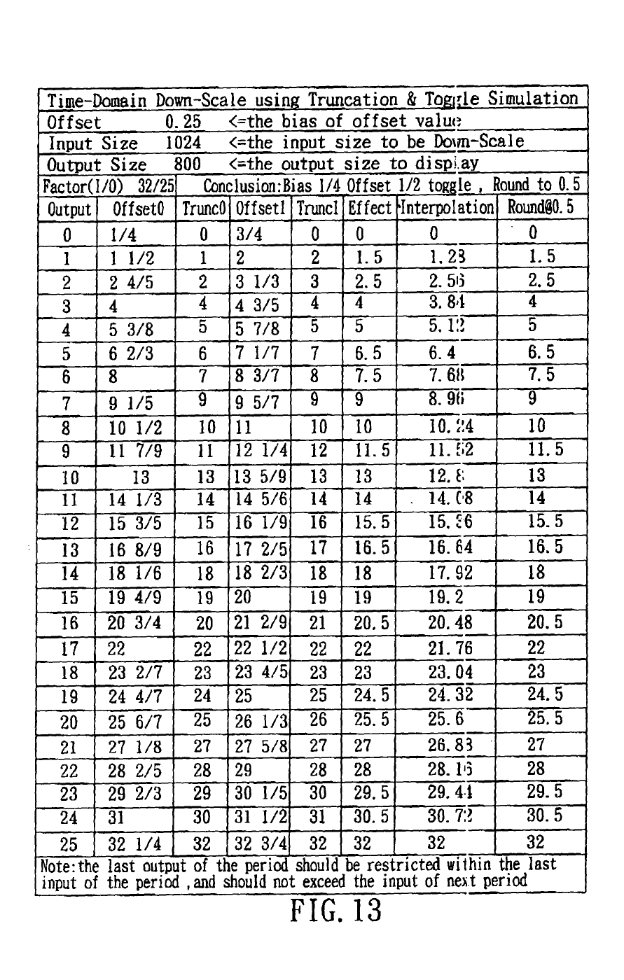

Another object for approaching the effect of simple interpolation with ½ accuracy is accomplished basing on the persistence of vision for continuous images, which can be considered as averaging a series of images forming a time sequence so as to achieve the effect of the simple interpolation with ½ accuracy. The design of the object can have better effect of proportion for the graphic image. Using the setting Offset0=¼, Offset1=¾ to down-scale 1024 pixels to 800 pixels can have the effect similar to the effect of simple interpolation with ½ accuracy with reference to FIG. 13.

$$Effect\_pixel = \frac{⌊ ( M / N * X ) + 1 / 4 ⌋ + ⌊ ( M / N * X ) + 3 / 4 ⌋}{2}$$

assuming K=└M/N*X)┘, that is, K equals to the integer portion of (M/N*X), and P equals to the decimal portion of (M/N*X),

$$if 0 \leq P < 1 / 4 , Effect\_pixel = \frac{K + K}{2} = K ;$$

$$if 1 / 4 \leq P < 3 / 4 , Effect\_pixel = \frac{K + ( K + 1 )}{2} = K + 0.5 ;$$

$$if 3 / 4 \leq P < 1 , Effect\_pixel = \frac{( K + 1 ) + ( K + 1 )}{2} = K + 1 ;$$

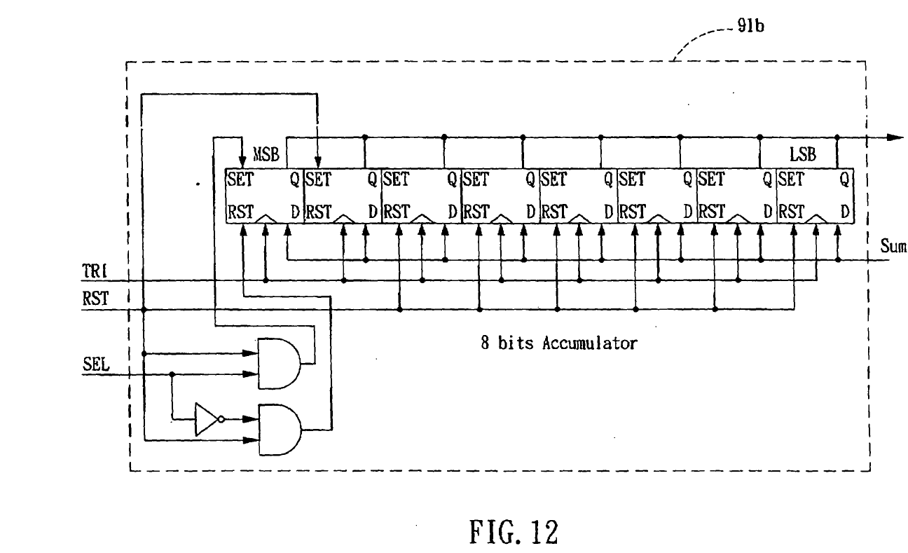

FIG. 12 is an embodiment of initial offset accumulator 91b with Offset0=¼, and Offset1=¾. The initial offset accumulator 91b resetting to be either 01000000b(Offset0=¼) or 11000000b(Offset1=¾) is according to SEL.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claim.

1. An apparatus for outputting a plurality of output frames according to a plurality of corresponding input frames, comprising:
a selector for selecting a plurality of first sampling positions for a first input frame and a plurality of second sampling positions for a second input frame, wherein said first sampling positions and said second sampling positions are not substantially the same; and
a decision unit for outputting a first output frame through sampling said first input frame according to said first sampling positions and outputting a second output frame through sampling said second input frame according to said second sampling positions.

2. The apparatus of claim 1, further comprising:
a data buffer for receiving the output of the decision unit, and outputting said output frame.

3. The apparatus of claim 1, wherein at least one of said first sampling positions is not included in said second sampling positions.

4. The apparatus of claim 1, wherein the resolution of said first input frame and the resolution of said first output frame are different.

5. The apparatus of claim 4, wherein the resolution of said first input frame is larger than the resolution of said first output frame.

6. The apparatus of claim 1, wherein said first input frame can be reproduced according to said first output frame and said second output frame.

7. The apparatus of claim 1, wherein each of said first and second sampling positions is chosen according to an offset value respectively, wherein said offset value of said first sampling positions is ¼, and said offset value of said second sampling positions is ¾.

8. The apparatus of claim 1, wherein each input frame comprises a plurality of horizontal lines, and each horizontal line comprises a plurality of pixels, wherein said selector further comprises:
a horizontal pixel selector for selecting a plurality of first sampling pixel positions of each horizontal line of the first input frame and a plurality of second sampling pixel positions of each horizontal line of the second input frame; and
a horizontal line selector for selecting a plurality of first sampling horizontal line positions of the first input frame and a plurality of second sampling horizontal line positions of the second input frame.

9. The apparatus of claim 8, wherein each of said first and second sampling pixel positions is chosen according to an offset value respectively, wherein said offset value of said first sampling pixel positions of is 0, and said offset value of said second sampling pixel positions is M/N−1, wherein M is the number of horizontal pixels of said input image, and N is the number of horizontal pixels of said output image.

10. The apparatus of claim 8, wherein each of said first and second sampling horizontal line positions is chosen according to an offset value respectively, wherein said offset value of said first sampling horizontal line positions is 0, and said offset value of said second sampling horizontal line positions is M/N−1, wherein M is the number of horizontal lines of said input image, and N is the number of horizontal lines of said output image.

11. The apparatus of claim 1, wherein said selector includes a flip-flop.

12. A method for sampling input image and outputting an output image, said input image comprising a plurality of image frames, each image frame comprising a plurality of pixels, said method comprising steps of:
selecting a plurality of first sampling positions for a first input frame and a plurality of second sampling positions for a second input frame, wherein said first sampling positions and said second sampling positions are not substantially the same; and
outputting a first output frame through sampling said first input frame according to said first sampling positions and outputting a second output frame through sampling said second input frame according to said second sampling positions.

13. The method of claim 12, wherein at least one of said first sampling positions is not included in said second sampling positions.

14. The method of claim 12, wherein the resolution of said first input frame and the resolution of said first output frame are different.

15. The method of claim 12, wherein said output image includes a first set of first output frames generated through sampling the first input frames according to said first sampling positions and a second set of second output frames generated through sampling the second input frames according to said second sampling positions.

16. The method of claim 12, wherein each of said first and second sampling positions is chosen according to an offset value respectively, wherein said offset value of said first sampling positions is ¼, and said offset value of said second sampling positions is ¾.

17. The method of claim 12, wherein each input frame comprises a plurality of horizontal lines, and each horizontal line comprises a plurality of pixels, wherein step of selecting comprises:
selecting a plurality of first sampling pixel positions of each horizontal line of the first input frame and a plurality of second sampling pixel positions of each horizontal line of the second input frame; and
selecting a plurality of first sampling horizontal line positions of the first input frame and a plurality of second sampling horizontal line positions of the second input frame.

18. The method of claim 17, wherein each of said first and second sampling pixel positions is chosen according to an offset value respectively, wherein said offset value of said first sampling pixel positions is 0, and said offset value of said second sampling pixel positions is equal to M/N−1, wherein M is the number of horizontal pixels of said input image, and N is the number of horizontal pixels of said output image.

19. The method of claim 17, wherein each of said first and second sampling horizontal line positions is chosen according to an offset value respectively, wherein said offset value of said first sampling horizontal line positions is 0, and said offset value of said second sampling horizontal line positions is M/N−1, wherein M is the number of horizontal lines of said input image, and N is the number of horizontal lines of said output image.

20. An apparatus for sampling an input image and outputting an output image, said input image comprising a plurality of input frames, each of said input frames comprising a plurality of pixels, said apparatus comprising:
a frame decision unit for grouping said input frames into at least a first set and a second set of input frames; and
a pixel selector, coupled to said frame decision unit, for sampling the first set of input frames according to a plurality of first sampling positions, and sampling the second set of input frames according to a plurality of second sampling positions;
wherein the first sampling positions and the second sampling positions are not substantially the same.
